(19) United States
(12) Patent Application Publication
(10) Pub. No.: US 2019/0270417 A1
(43) Pub. Date: Sep. 5, 2019

(54) INTEGRATED POWER BOX

(71) Applicant: Dr. Ing. h.c. F. Porsche Aktiengesellschaft, Stuttgart (DE)

(72) Inventors: Daniel Spesser, Illingen (DE); Fabian Grill, Eppingen (DE)

(73) Assignee: Dr. Ing. h.c. F. Porsche Aktiengesellschaft, Stuttgart (DE)

(21) Appl. No.: 16/282,443

(22) Filed: Feb. 22, 2019

(30) Foreign Application Priority Data
Mar. 5, 2018 (DE) 102018104914.5

(51) Int. Cl. B60R 16/033; H02J 7/02; H02J 7/04; H01M 10/625; H01M 10/46

(52) U.S. Cl. CPC B60R 16/033; H02J 7/022; H01M 2220/20; H01M 10/625; H01M 10/46; H02J 7/04

(57) ABSTRACT

A power arrangement for a vehicle includes an AC charger for connecting to an external AC voltage supply and providing an HV DC voltage for the vehicle, an HV temperature regulating device for regulating the temperature of an HV battery storage device of the vehicle, a DC/DC converter for converting the HV DC voltage into an on-board electrical system voltage of the vehicle, and an HV voltage distribution for distributing the HV DC voltage n the vehicle. The AC charger is embodied using semiconductor technology without galvanic isolation. The power arrangement includes a housing, in which the AC charger, the HV temperature regulating device, the DC/DC converter and the HV voltage distribution are arranged to form an integrated power box. Also described is a vehicle including the abovementioned power arrangement.

### CROSS-REFERENCE TO RELATED APPLICATION

This application claims priority to German Patent Application No. DE 10 2018 104 914.5, filed Mar. 5, 2018, which is incorporated by reference herein in its entirety.

### FIELD OF THE INVENTION

The present invention relates to a power arrangement for a vehicle comprising an AC charger for connecting to an external AC voltage supply and providing an HV DC voltage for the vehicle, an HV temperature regulating device for regulating the temperature of an HV battery storage device of the vehicle, a DC/DC converter for converting the HV DC voltage into an on-board electrical system voltage of the vehicle, and an HV voltage distribution for distributing the HV DC voltage in the vehicle.

Furthermore, the invention relates to a vehicle comprising an abovementioned power arrangement.

### BACKGROUND OF THE INVENTION

The increasing spread of electric drives in vehicle construction is changing the way in which these vehicles are constructed. At present vehicles having electric drives are often still small-series models, the manufacture of which is very costly. In order to enable electric drives also to spread in mass-produced models with increasing numbers, optimizations vis-à-vis the previous designs are therefore required. Current vehicle architectures need to be analyzed and optimized.

In order to enable an electric drive, a supply with high voltage (HV) as DC voltage in the region of at present several hundred volts is provided in the vehicle. Vehicles having electric drives therefore typically comprise an AC charger, an HV temperature regulating device, a DC/DC converter and an HV voltage distribution. These HV components together form a power arrangement for high voltage. In addition, a vehicle having an electric drive usually comprises an HV battery storage device for storing electrical energy. In the HV battery storage device, a plurality of individual battery cells are interconnected in series with one another in order to provide HV DC voltage. A greater current can be provided by way of a parallel arrangement of such strings of battery cells. If appropriate, the voltage provided by the HV battery storage device is increased to the HV DC voltage by a DC/DC conversion.

The HV components mentioned above are currently provided individually in the vehicle, that is to say that each of the HV components comprises a dedicated housing, is fitted separately in the vehicle, individually electrically cabled and located in the vehicle, and comprises a dedicated cooling system with a separate cooling hose arrangement. This causes a high assembly outlay, and causes a high weight and a large package overhead.

Via the AC charger, the vehicle can be connected to an external AC voltage supply for the charging of the HV battery storage device of said vehicle. For safety reasons, present-day AC chargers are embodied with an isolation transformer in order to bring about a galvanic isolation between the AC voltage supply and an HV DC voltage in the vehicle. The galvanic isolation affords protection against electric shocks and prevents DC feedback from the vehicle to the external AC voltage supply. Said galvanic isolation requires a comparatively large amount of space in the AC charger, has a high weight and is usually expensive.

In this context, DE 11 2006 003 033 T5, which is incorporated by reference herein, discloses a system and a method for the general control of power converters.

Moreover, DE 10 2015 219 917 A1, which is incorporated by reference herein, discloses a power conversion module for a vehicle. The module comprises a housing and a power conversion unit installed on an inner surface of a base panel of the housing. The power conversion unit comprises a capacitor module, a power module, of an inverter, and an LDC. A water-cooling-type cooling unit is installed on an outer surface of the base panel of the housing and is arranged in a position corresponding to the power module of the inverter and the LDC, wherein the base panel of the housing is interposed therebetween. An air-cooling-type cooling rib is installed on the external surface of the base panel and is arranged in a position corresponding to a capacitor module, wherein the base panel of the housing is interposed therebetween.

Furthermore, DE 10 2014 016 076 A1, which is incorporated by reference herein, discloses a DC/DC converter for a motor vehicle comprising two high-voltage terminals, a high-voltage DC/AC converter having a high-voltage converter switch, a galvanically isolated transformer, a low-voltage AC/DC converter, a link circuit having a link circuit capacitance, and a converter module connected to the link circuit and serving for converting a link circuit voltage of the link circuit into a low-voltage DC voltage. The converter module comprises two low-voltage terminals. A drive device of the high-voltage converter switch is designed to drive the high-voltage converter switch with a predefined and fixed duty ratio, such that the transformation ratio of a high-voltage DC voltage and the link circuit voltage, which ratio is realized via the high-voltage DC/AC converter, the transformer and the low-voltage AC/DC converter, is constant.

In addition, DE 10 2015 223 655 A1, which is incorporated by reference herein, discloses an AC/DC converter of an energy conversion device, which converter comprises filters, a PFC circuit, a first full-bridge circuit, a first transformer and a first rectifier circuit and converts an externally supplied AC voltage into a DC voltage. A DC/DC converter comprises filters, a second full-bridge circuit, a second transformer and a second rectifier circuit and reduces a DC voltage output by the AC/DC converter. Circuit constituents of the AC/DC converter that are located on the primary side of the first transformer are fitted on the upper surface of a cooling housing, which cools both converters. Circuit constituents of the AC/DC converter that are located on the secondary side of the first transformer and circuit constituents of the DC/DC converter are fitted on the lower side of the cooling housing.

### SUMMARY OF THE INVENTION

Proceeding from the prior art mentioned above, described herein is a power arrangement and a vehicle comprising a power arrangement of the type mentioned above, wherein the power arrangement can be produced efficiently, is simple to mount, has a low weight, has a small design, generates low electrical losses and in addition can be provided in a cost-effective manner.

Described herein is a power arrangement for a vehicle that comprises an AC charger for connecting to an external AC voltage supply and providing an HV DC voltage for the vehicle, an HV temperature regulating device for regulating the temperature of an HV battery storage device of the vehicle, a DC/DC converter for converting the HV DC voltage into an on-board electrical system voltage of the vehicle, and an HV voltage distribution for distributing the HV DC voltage in the vehicle, wherein the AC charger is embodied using semiconductor technology without galvanic isolation, and the power arrangement comprises a housing, in which the AC charger, the HV temperature regulating device, the DC/DC converter and the HV voltage distribution are arranged to form an integrated power box.

Also described herein is a vehicle comprising an abovementioned power arrangement.

A basic concept of the present invention is therefore that of providing an integrated power box by means of an intelligent combination of HV functions (high-voltage functions), said integrated power box enabling advantages with regard to package, efficiency, weight, costs and effectiveness. In this regard, firstly line paths between individual components, i.e. the AC charger, the HV temperature regulating device, the DC/DC converter and the HV voltage distribution, can be reduced by the common arrangement. This concerns both electrical cables and for example coolant lines for cooling the individual components of the integrated power box, as a result of which cable lengths and cooling line lengths can be reduced and weight is saved. Moreover, in a conventional design each of the components has to be connected individually in each case. The integrated power box can be mounted efficiently by comparison with individual mounting of the components. An additional optimization of the AC charger with a traditional transformer being dispensed with here yields various degrees of freedom in the configuration of the integrated power box. Such an AC charger additionally has a high efficiency.

The vehicle is, in particular, a vehicle having an electric drive that is supplied with electrical energy via the integrated power box. The vehicle can be driven exclusively electrically, or, as a so-called hybrid vehicle, comprise a combination of an electric drive and a further drive, for example a conventional internal combustion engine.

The AC charger serves for connecting to an external AC voltage supply and for converting the external AC voltage into an HV DC voltage that is provided in the vehicle. In the case of a vehicle having electrical energy generation, also known as a range extender, in principle it is also possible for electrical energy from the range extender to be converted via the AC charger and conducted into the HV battery storage device or the drive. The AC charger is embodied as a power electronic element using semiconductor technology without galvanic isolation. This makes it possible to provide an AC charger and correspondingly to provide an integrated power box which have a low weight. Moreover, the omission of a transformer makes it possible to reduce a required structural space. The AC charger can be connected to the external AC voltage supply via a charging cable or inductively.

The HV temperature regulating device serves for regulating the temperature of the HV battery storage device of the vehicle. A heat transfer fluid typically flows through the HV battery storage device and can heat and/or cool the HV battery storage device, for example depending on a battery load, an operating mode and/or ambient conditions. In this regard, the HV temperature regulating device can comprise an HV heater that heats the heat transfer fluid at low temperatures. The heated fluid flows through a battery circuit in order to bring the HV battery storage device to a higher temperature level and to achieve an associated reduction of internal resistance. A higher available system power can accordingly be achieved. If the temperature of the HV battery storage device rises above a limit value, the HV temperature regulating device can cool the HV battery storage device in order to protect the battery cells. The HV temperature regulating device is located in the integrated power box such that it is positioned ideally in the fluid circuit. By way of example, heat rocks or a planar resistor are used as heating elements in the HV heater. The planar resistor is located in the integrated power box over a large area, thereby ensuring maximum heat introduction into the battery circuit via a specific thermally conductive material. The HV temperature regulating device is embodied with semiconductor switching elements for driving purposes.

The DC/DC converter carries out a conversion of the HV DC voltage into an on-board electrical system voltage of the vehicle. The DC/DC converter converts the HV DC voltage, as provided by the AC charger or an HV battery storage device of the vehicle for the drive, to the on-board electrical system voltage of the vehicle. The HV DC voltage can be approximately 800V, for example. The on-board electrical system voltage is typically 12V, but can also assume values of 24V or 48V. The DC/DC converter is preferably embodied as a power electronic element using semiconductor technology, for example as a step-up or step-down converter, or as a boost converter.

The HV voltage distribution enables a distribution of the HV DC voltage in the vehicle. In principle arbitrary HV consumers can be supplied with the HV DC voltage via the HV voltage distribution. In particular, an electric drive of the vehicle is connected to the HV voltage distribution. To that end, the HV voltage distribution typically comprises a plurality of busbars and switching devices for connecting up and disconnecting individual branches. In order to facilitate maintenance and/or repair, the HV voltage distribution is positioned in an upper region in the integrated power box, such that it is easily accessible from above upon mounting in an engine compartment of the vehicle.

The housing is embodied as a common housing of all the components, that is to say that it s encompasses the AC charger, the HV temperature regulating device, the DC/DC converter and the HV voltage distribution. In addition, a common connection to a cooling system can be provided via the housing. The housing is preferably produced from lightweight construction materials. Such lightweight construction materials comprise for example plastics or light metals such as aluminum, wherein plastics or other electrically nonconductive materials are preferred.

By virtue of the embodiment of the power arrangement as an integrated power box, by way of example, a single cooling system for the power box can jointly cool all the components contained therein. The cooling system dissipates heat such as arises at line and contact resistances of the electrical components and their connections to one another, in order to prevent damage as a result of overheating and in order to reduce ohmic resistances by lowering the temperature.

In an advantageous configuration of the invention, the power arrangement comprises safety function hardware for electrically safeguarding the AC charger. Preferably, the safety function hardware is an integral part of the AC charger. The safety function hardware becomes active in the case of a fault, in order to afford protection of the vehicle. In particular, the safety function hardware is embodied and arranged to carry out an isolation of the AC charger from the external AC voltage supply in the case of a fault. The safety function hardware typically comprises a plurality of switching elements. The switching elements can be embodied electromechanically, for example as a contactor, or purely electronically with power semiconductors. An embodiment with power semiconductors is preferred.

In an advantageous configuration of the invention, the power arrangement comprises a safety device for isolating the DC/DC converter. Preferably, the safety device is an integral part of the DC/DC converter. The safety device becomes active in the case of a fault, in order to afford protection of the vehicle. In particular, the safety device is embodied and arranged to carry out an isolation of the DC/DC converter in the case of a fault. The safety device typically comprises a plurality of switching elements. The switching elements can be embodied electromechanically, for example as a contactor, or purely electronically with power semiconductors. An embodiment with power semiconductors is preferred.

In an advantageous configuration of the invention, the power arrangement comprises a switching device for switching the HV voltage distribution. Preferably, the switching device is an integral part of the HV voltage distribution. The switching device typically comprises a plurality of switching elements. The switching elements can be embodied electromechanically, for example as a contactor, or purely electronically with power semiconductors. An embodiment with power semiconductors is preferred.

In an advantageous configuration of the invention, the power arrangement has a modular construction comprising at least two modules, in particular comprising a respective module for the AC charger, the HV temperature regulating device, the DC/DC converter and the HV voltage distribution. By virtue of the modular construction, differently configured integrated power boxes can be provided in a simple manner by selecting individual modules as necessary and combining them to form the integrated power box. Moreover, a modular construction facilitates an exchange of individual modules in the case of a failure or damage. Here the modules can be selected and combined not just depending on their electrical function, but additionally taking account of structural sizes and mechanical requirements. Accordingly, different vehicle platforms can be accommodated. Here a sufficient sealing concept of the modules among one another is important in order to ensure the safety of the components contained.

In an advantageous configuration of the invention, the housing is embodied as a crash-relevant structure for stabilizing the vehicle, in particular as a stabilization strut for at least a few vehicle domes. Consequently, besides its electrical function, the integrated power box can form a structural component part that reinforces a stability of the vehicle. In this regard, a correspondingly configured housing makes it possible to omit one or more dome struts in the front end of the vehicle for the stabilization of the whole vehicle. Accordingly, the integrated power box can be fitted for example between two front domes, wherein a respective holder connection from the respective front dome is screwed to the integrated power box. The integrated power box can thus perform the function of one or more dome struts.

In an advantageous configuration of the invention, the housing has at least one service flap enabling access to exchangeable components of the power arrangement. Such exchangeable components are fuses, in particular, such that a simple exchange is possible after a case of a fault. The fuses are in particular HV fuses, for example for safeguarding the AC charger. Preferably, the integrated power box additionally comprises an evaluation circuit, which monitors and if appropriate reports proper installation of the fuses and/or opening of the service flap. Furthermore, an electronic unit of a module can also be completely exchangeable via a service flap.

In an advantageous configuration of the invention, internal electrical connections between the AC charger, the HV temperature regulating device, the DC/DC converter and the HV voltage distribution are embodied according to a “blade” technology. Using blade technology, an electrical connection comprises a blade and a Faston. During production of the electrical connection, the blade plunges into the Faston and contacts the latter by means of friction and pressure processes. Blade technology is designed to enable a connection between the blade and the Faston to be repeatedly established and is disconnected again.

In an advantageous configuration of the invention, the power arrangement comprises an internal communication connection that connects the AC charger, the HV temperature regulating device, the DC/DC converter and the HV voltage distribution to one another. The communication connection can be produced for example on the basis of an internal communication bus widely used in the automotive sector, for example CAN, SPI or LIN or else Ethernet. Preferably, the communication connection is shielded against electromagnetic irradiation, in order to satisfy requirements in respect of electromagnetic compatibility (EMC).

### BRIEF DESCRIPTION OF THE DRAWING

The invention is explained by way of example below on the basis of preferred exemplary embodiments with reference to the appended drawings, wherein the features presented below can constitute an aspect of the invention both individually in each case and in combination.

In the figures:

FIG. 1: shows a perspective illustration of a power arrangement in accordance with a first, preferred embodiment comprising an AC charger, an HV temperature regulating device, a DC/DC converter and an HV voltage distribution, which are arranged in a common housing to form an integrated power box,

FIG. 2: shows a schematic illustration of the AC charger from FIG. 1 comprising an input filter, a rectifier, a power factor correction filter, a smoothing element, a DC/DC converter and an output filter, and

FIG. 3: shows a functional, schematic illustration of the AC charger from FIG. 2 comprising an additionally illustrated current monitoring device and a likewise additionally Illustrated disconnection device.

### DETAILED DESCRIPTION OF THE INVENTION

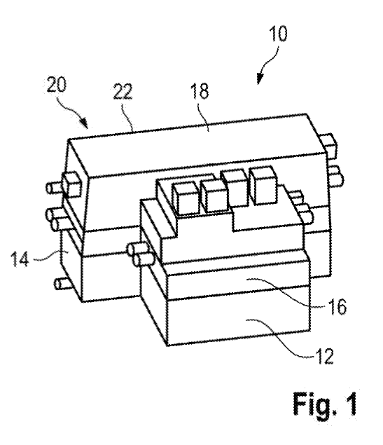

FIG. 1 shows a power arrangement 10 according to aspects of the invention for a vehicle in accordance with a first, preferred embodiment. The vehicle of the first embodiment is an electric vehicle having an electric drive that is supplied with electrical energy via the power arrangement 10.

The power arrangement 10 comprises an AC charger 12, an HV temperature regulating device 14, a DC/DC converter 16 and an HV voltage distribution 18, which are arranged in a common housing 22 to form an integrated power box 20. Internal electrical connections between the AC charger 12, the HV temperature regulating device 14, the DC/DC converter 16 and the HV voltage distribution 18 are embodied using “blade” technology.

The AC charger 12 serves for connecting to an external AC voltage supply 38 and for converting the AC voltage delivered via the latter into an HV DC voltage 40 that is provided in the vehicle. The AC charger 12 is embodied as a power electronic element using semiconductor technology without galvanic isolation. The AC charger 12 is connected to the external AC voltage supply 38 via a charging cable.

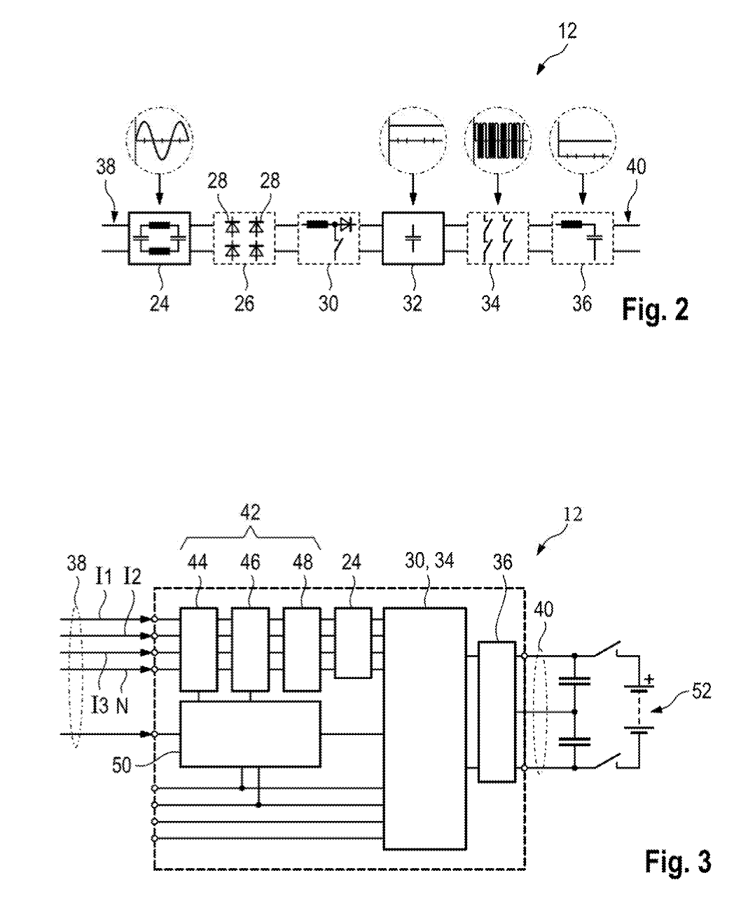

The AC charger 12 of the first embodiment is partly illustrated in detail in each case in FIGS. 2 and 3. Here the illustration in FIG. 2 is based on a functional construction such as is used in AC chargers 12 known per se. Accordingly, the AC charger 12 comprises, as functional components, an input filter 24, a rectifier 26 having a plurality of semiconductor switching elements 28, a power factor correction filter 30, a smoothing element 32, a DC/DC converter 34 and an output filter 36, which are interconnected in series in this order. The AC charger 12 is connected to the AC voltage supply 38 on the input side and delivers the HV DC voltage 40 on the output side.

The AC charger 12 additionally comprises safety function hardware 42 for electrically safeguarding the AC charger 12, said hardware being illustrated in FIG. 3. In the case of a fault, the safety function hardware 42 carries out an isolation of the AC charger 12 from the external AC voltage supply 38. To that end, the safety function hardware 42 comprises an isolation device 44 comprising a plurality of switching elements (not illustrated individually), which interrupt the connection to the AC voltage supply 38 upon actuation. The switching elements are embodied electronically with power semiconductors.

The safety function hardware 42 additionally comprises a differential current monitoring 46, which monitors differential currents in the three phases I1, I2, I3 and the neutral conductor N of the external AC voltage supply 38. The safety function hardware 42 furthermore comprises a compensation device 48. A monitoring device 50 receives differential currents measured in the differential current monitoring 46 in order to identify faults. In the case of a fault, the current monitoring device 50 drives the isolation device 44 in order to isolate the AC charger 12 from the external AC voltage supply 38, or the compensation device 48 in order to carry out a current compensation. In addition, the DC/DC converter 34 is also driven by the monitoring device 50, for example in order to deactivate the DC/DC converter 34 in the event of a fault in the AC charger 12.

As illustrated in FIG. 3, in accordance with the explanations with regard to FIG. 2, the AC charger 12 comprises an input filter 24, which is designated here as EMC filter. The DC/DC converter 34 together with the power factor correction filter 30 is connected downstream of the input filter 24. DC/DC converter 34 and power factor correction filter 30 are embodied integrally here. The output filter 36 is also connected downstream in this illustration.

On the output side, the HV DC voltage 40 thus provided is illustrated here with an HV battery storage device 52. The HV temperature regulating device 14, the DC/DC converter 16 and the HV voltage distribution 18 are also connected to the HV DC voltage 40.

The HV temperature regulating device 14 serves for regulating the temperature of the HV battery storage device 52 of the vehicle. The HV temperature regulating device 14 is embodied here as an HV heater 14. A heat transfer fluid flows through the HV battery storage device 52 in order to heat the HV battery storage device 52. In this case, the HV heater 14 heats the heat transfer fluid. The HV temperature regulating device 14 is embodied with semiconductor switching elements for driving purposes.

The DC/DC converter 16 converts the HV DC voltage 40, as provided by the AC charger 12 or the HV battery storage device 52 of the vehicle, to an on-board electrical system voltage of the vehicle. The HV DC voltage 40 here has a value of 800V, and the on-board electrical system voltage is 12V. In an alternative embodiment, the on-board electrical system voltage has a value of 24V or 48V. The DC/DC converter 16 is embodied as a power electronic element using semiconductor technology. Moreover, the DC/DC converter 16 comprises a safety device for isolating the DC/DC converter 16. The safety device is embodied and arranged to carry out an isolation of the DC/DC converter 16 in the case of a fault. The safety device typically comprises a plurality of switching elements. The switching elements are embodied electronically with power semiconductors.

The HV voltage distribution 18 distributes the HV DC voltage 40 in the vehicle. Consumers in the vehicle are supplied with the HV DC voltage 40 via the HV voltage distribution 18. This concerns in particular an electric drive of the vehicle. The HV voltage distribution 18 is positioned in an upper region in the housing 22. The HV voltage distribution 18 comprises a plurality of busbars and a switching device for connecting up and disconnecting individual supply branches. The switching device is embodied with individual switching elements that are embodied electronically with power semiconductors.

The power arrangement 10 comprises an internal communication connection (not illustrated here) that connects the AC charger 12, the HV temperature regulating device 14, the DC/DC converter 16 and the HV voltage distribution 18 to one another. The internal communication connection is connectable to a control device of the vehicle via an interface formed at the housing 22.

The housing 22 is embodied as a common housing 22 of all the components 12, 14, 16, 18, in which housing the AC charger 12, the HV temperature regulating device 14, the DC/DC converter 16 and the HV voltage distribution 18 are arranged. A common connection of the integrated power box 10 to a cooling system is effected via the housing 22. The housing 22 is produced from plastic. The housing 22 has a service flap enabling access to exchangeable components of the power arrangement 10.

The housing 22 is embodied as a crash-relevant structure for stabilizing the vehicle. In the mounted state in the housing 22 the power arrangement 10 is fitted as a stabilization strut, also called dome strut, between two front domes of the vehicle. To that end, a respective holder connection from the respective front dome is screwed to the integrated power box 20.

The power arrangement 10 of the first embodiment has a modular construction, wherein the AC charger 12, the HV temperature regulating device 14, the DC/DC converter 16 and the HV voltage distribution 18 are in each case embodied as individual modules and connected to form the integrated power box 20. In this case, the individual modules are sealed relative to one another in order to seal the housing 22 overall.

What is claimed is:

1. A power arrangement for a vehicle, said power arrangement comprising:
an AC charger for connecting to an external AC voltage supply and providing an HV DC voltage for the vehicle, wherein the AC charger is embodied using semiconductor technology without galvanic isolation,
an HV temperature regulating device for regulating the temperature of an HV battery storage device of the vehicle,
a DC/DC converter for converting the HV DC voltage into an on-board electrical system voltage of the vehicle,
an HV voltage distribution for distributing the HV DC voltage in the vehicle, and a housing, in which the AC charger, the HV temperature regulating device, the DC/DC converter and the HV voltage distribution are arranged to form an integrated power box.

2. The power arrangement as claimed in claim 1, wherein the power arrangement comprises safety function hardware for electrically safeguarding the AC charger.

3. The power arrangement as claimed in claim 1, wherein the power arrangement comprises a safety device for isolating the DC/DC converter.

4. The power arrangement as claimed in claim 1, wherein the power arrangement comprises a switching device for switching the HV voltage distribution.

5. The power arrangement as claimed in claim 1, wherein the power arrangement has a modular construction comprising respective modules for the AC charger, the HV temperature regulating device, the DC/DC converter and the HV voltage distribution.

6. The power arrangement as claimed in claim 1, wherein the housing is embodied as a crash-relevant structure for stabilizing the vehicle as a stabilization strut for at least a few vehicle domes.

7. The power arrangement as claimed in claim 1, wherein the housing has at least one service flap enabling access to exchangeable components of the power arrangement.

8. The power arrangement as claimed in claim 1, wherein internal electrical connections between the AC charger, the HV temperature regulating device, the DC/DC converter and the HV voltage distribution are embodied according to a blade technology.

9. The power arrangement as claimed in claim 1, wherein the power arrangement comprises an internal communication connection that connects the AC charger, the HV temperature regulating device, the DC/DC converter and the HV voltage distribution to one another.

10. A vehicle comprising the power arrangement as claimed in claim 1.
